(19) United States
(12) Patent Application Publication
(10) Pub. No.: US 2023/0322169 A1
(43) Pub. Date: Oct. 12, 2023

(54) Cladding Part Having a Textile Covering

(71) Applicant: Bayerische Motoren Werke Aktiengesellschaft, Muenchen (DE)

(72) Inventors: Thomas AUMANN, Buch am Erlbach (DE); Florian DECHANT, Adlkofen (DE); Johann GASSLHUBER, Buch am Erlbach (DE); Dienhung HUYNH, Landshut (DE)

(21) Appl. No.: 18/119,907

(22) Filed: Mar. 10, 2023

(30) Foreign Application Priority Data
Apr. 6, 2022 (DE) 10 2022 108 220.2

(51) Int. Cl. B60R 13/02

(52) U.S. Cl. CPC B60R 13/0243; B60R 13/025

(57) ABSTRACT

A cladding part has a textile covering, wherein the covering forms a visible surface of a wall. At least one wall portion of the covering is transferable into a position in which the wall portion forms at least one outer wall region of a receptacle.

### CROSS REFERENCE TO RELATED APPLICATION

This application claims priority under 35 U.S.C. § 119 from German Patent Application No. 102022108220.2, filed Apr. 6, 2022, the entire disclosure of which is herein expressly incorporated by reference.

### BACKGROUND AND SUMMARY

The present invention relates to a cladding part having a textile covering.

In contemporary vehicle construction, surfaces in the vehicle interior or in the passenger compartment of motor vehicles are provided with decorative elements in order to create an appealing visual impression for the occupants of the vehicle. For the interior trim parts, or cladding parts, there is a multiplicity of surface variants (leather, artificial leather, films, textiles) that are applied to a carrier by various laminating methods. At present, for laminated interior trim parts, e.g. a knitted spacer fabric, a foam backing or nonwoven fabric is used as a haptic layer. In this context, it has become customary to adhesively bond decorative elements, for example in the form of films with the visual appearance of wood or carbon, to a plastic carrier. In addition, it is also known to mount skins of leather or artificial leather on carrier structures using laminating methods, e.g. press laminating methods or similar laminating methods, e.g. without a fixed upper tool, in order to create the visual appearance of leather. In the course of this laminating operation, the films or the skins are materially bonded to the underlying carrier structure using an adhesive. The heat needed to activate the adhesive is introduced into the adhesive joint through the skin via a hot press die of the press laminating tool by way of contact heat or by means of IR radiation. This activates the adhesive during the laminating method and connects the film or the skin to the carrier structure.

Many of these surfaces, however, have restrictions in terms of the possible uses of the cladding parts in the vehicle interior owing to the materials used and owing to the production method used.

US 2016/0229338 A1 discloses the provision and backlighting of cladding parts with a knitted surface.

DE 198 55 540 A1 discloses a seat covering in which different additional functional elements are integrated.

DE 198 47 333 A1 discloses a method for producing knitted fabrics with integrated fastening elements.

Taking this prior art as a starting point, the object of the present invention is to provide a cladding part which overcomes the disadvantages of the prior art. It is a particular object of the invention to provide a cladding part which is distinguished by good ergonomic properties.

This object is achieved by a cladding part according to the features of the independent claim. Further embodiments are specified in the dependent claims.

To achieve this object, the invention proposes a cladding part having a textile covering, the covering forming a visible surface of a wall. Suitable textiles in this context are in particular knitted-fabric material, woven-fabric material, stitch-bonded-fabric material, mesh material, etc. The covering can have at least one wall portion which can be transferred into a position in which the wall portion forms at least one outer wall region of a receptacle, or a cavity, or an indentation. Forming the wall portion from textile offers the advantage over placement surfaces of hard plastic that it is possible to realize a flexible surface offering ergonomic advantages. This flexibility of the textile also leads to a reduction in the risk of injury to the occupants of the vehicle in the event of a crash, since a textile storage compartment is considerably more flexible, or deformable, than a storage compartment of hard plastic with inflexible contours.

Furthermore, the wall portion may be transferable into a position in which the cladding part does not have a receptacle, or cavity, or indentation. In other words, in this position, the wall portion is in a folded-in state, so that it does not form a receptacle, or a storage compartment. This makes it possible to free up more interior installation space and thus improve the space conditions, which are always very limited. This relates in particular to use cases in which the cladding part is in the form of door cladding, in the case of which the placement surface usually penetrates the footwell of the driver or front-seat passenger.

The wall portion may be transferable from a first position in which the wall portion forms at least one outer wall region of a receptacle, or a cavity or an indentation, into a position in which the cladding part does not have a receptacle, or cavity, or indentation, and vice versa. In other words, the outer wall region of the covering can be folded out, so that it forms at least one outer wall region of a storage compartment. The wall portion can be folded open into a first position in which it encloses a receptacle, a cavity, an indentation, or a storage compartment, at least in certain portions. This offers the advantage that the receptacle can be used as a storage compartment when required. However, the wall portion can also be folded in, so that it does not form a storage compartment. Therefore, the loss of installation space, for example in a vehicle interior, is reduced to the cases in which it is actually necessary to use a storage compartment.

The surface covering may be formed from a textile throughout, with not just the wall portion but also the surrounding regions of the covering being formed from textile. This offers the advantage that the interior decoration in the vehicle interior is continuous and thus forms a homogeneous, visually extremely appealing appearance.

Furthermore, the wall portion may have a stiffening. The stiffening exerts a force on the wall portion which keeps the wall portion in a folded-in state. In a folded-out state, the stiffening exerts a force on the wall portion which keeps the wall portion in an open state.

Furthermore, the wall portion may have a stiffening in its end which is uppermost counter to gravitational force. This offers the advantage that the upper terminating edge of the wall portion is formed with a stiffening, which shapes the contour of the wall portion. In a folded-out state, in which a storage compartment is formed, it is consequently possible to form a dimensionally stable opening in the storage compartment with improved engagement. The contour-defining stiffening element, however, also offers the advantage that the opening and closing of the storage compartment, i.e. the folding-out and folding-in of the wall portion, are made easier.

As an alternative, the stiffening may be applied partially or else to the entire surface area of the wall portion, with the result that the restoring effect can result not only from a partial region at the upper end of the wall portion but from the entire surface area of the wall portion.

In all the alternatives mentioned, the stiffening may be in the form of a mesh, or mesh woven fabric, or a leaf spring.

The textile may have sufficient intrinsic stability, or stiffness. This offers the advantage that, in the folded-in state, the wall portion closely follows the carrier structure of the carrier part in a dimensionally stable manner. In the folded-out state, the intrinsic stability offers the advantage that a desired form of the outer wall is maintained by the textile.

In addition, an illumination device that emits light may be provided. In a position in which the cladding part does not have a receptacle and therefore the wall portion is in a folded-in state, the wall portion may be translucent. In this way, it is particularly easily possible to backlight the passenger compartment, what is referred to as ambient lighting.

Furthermore, it is possible for the wall portion to not be translucent in a position in which the wall portion forms at least one outer wall region of a receptacle, or cavity, or indentation. This offers the advantage that the illumination device is used as lighting for the storage compartment. By reducing the translucent properties of the outer wall region, or of the wall portion, it is possible to have the effect of increasing the brightness inside the storage compartment.

Of course, as an alternative, it is also possible for the outer wall region to continue to be translucent even when the wall portion is in a folded-out position. This makes it possible not only to achieve good illumination of the inner region of the storage compartment, but also to backlight the passenger compartment at the same time.

The cladding part is preferably an interior component for the vehicle interior of a vehicle, such as instrument panels, door claddings, claddings for the A pillars, B pillars, etc., sunshades, back seat area compartments, arm rests, central consoles, closable storage compartments such as glove boxes, etc. Glove boxes may be provided with cladding both on the outside and inside. However, the cladding part may also be used to clad seats and/or headrests. Therefore, 2D/3D knitted fabrics can be used as interior surfaces that have a decorative seam integrated during the knitting process for the purpose of creating a component.

However, the cladding part may also be used for other means of transport, such as aircraft, ships, trains etc. The use of the cladding part in furniture or furnishings is also contemplated.

A knitted material, or knitted fabric, should be understood to mean a sheet-like textile in the context of the invention. The knitted fabric is preferably formed from a front-side knitted fabric and a back-side knitted fabric, the front-side knitted fabric and the back-side knitted fabric preferably each being produced from a yarn or monofilament. The yarn according to the invention is, in turn, formed from a multiplicity of filaments. For example, a yarn comprises 50 to 100, in particular 70, filaments. The filaments are preferably manufactured from a plastic and/or aramid and/or a similar material. A 3D knitted fabric is manufactured in a three-dimensional manner by way of its special production process and consequently differs from a two-dimensional, flat knitted fabric both in terms of handling and manufacturing and the requirements for fastening and processing. A 3D knitted fabric is generally manufactured for the covering over a carrier component and advantageously enables processing with reduced offcuts or even without offcuts.

The advantages of the invention are to be briefly summarized below. By replacing the previously known plastics components with textile composite materials, in particular textiles, it is possible to realize flexible component surfaces. The use of textiles with intrinsically stiff properties makes it possible to largely dispense with the use of an underlying substrate. Its intrinsically stable properties enable the knitted fabric to span regions of the substrate in which the substrate has openings or apertures, without the edges of the openings being reproduced on the surface of the cladding part, or the knitted fabric. The saving on component materials for the substrate thus leads to a reduction in the overall weight of the cladding part. Using the textiles, it is possible to present high-quality surface materials without an underlying carrier structure, or without an underlying substrate. Advantages result not least for the production of the cladding part according to the invention, because the manufacturing process is facilitated. In particular, there are no preliminary processes for the component manufacture, because, for example, the production of the substrate is made easier. When textiles with intrinsically stiff properties are used, it is possible to save on a deposition of adhesive to bond the substrate to the covering and thus the laminating of the substrate to the covering forming the surface can be made easier.

In particular, the receptacle, cavity, indentation, or placement surface within the meaning of this invention can be understood as meaning in particular map pockets, bottle holders, pockets, flaps, bags/pouches for small parts and similar depressions.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view of a cladding part with a folded-out wall portion; and

FIG. 2 is a perspective view of a cladding part with a folded-in wall portion.

### DETAILED DESCRIPTION OF THE DRAWINGS

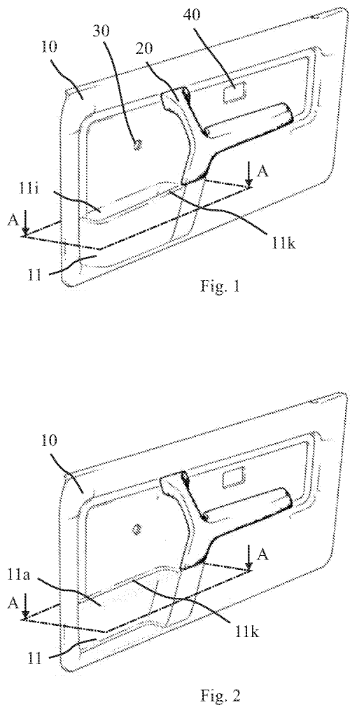

FIG. 1 shows a perspective view of a door cladding panel 10, which is to be understood, for example, as a cladding part 10 within the meaning of the invention. The door cladding panel 10 comprises a door handle 20 with adjoining armrests. Also provided is an aperture 30 through which, for example, a window crank lever or the like can be guided. The cutout 40 is used to guide through the handle of the door opening mechanism. The cladding part 10 is provided with a cover, which is not visible in more detail. This cover is a textile surface covering and forms a surface, or outer wall 10o, of the cladding part. In the lower region of the door cladding, on the left in the figures, a wall portion 11 of the surface covering, or the wall 10o, forms a bulge, or a protruding region. This protruding region constitutes a receptacle which encloses a receptacle inner region 11i. Objects, such as bottles, maps, purses/wallets, mobile phones and the like can be placed into this inner region 11i.

The wall portion 11 is flexible and can be folded in, so that it is transferred into a position depicted in FIG. 2. In the process, the wall portion 11 is folded in so that it closely follows the contour of the surface of a substrate of the cladding part 10. In this position, the wall portion 11 frees up the packing space 11a, which is then available in the passenger compartment.

A stiffening element may be provided along the upper contour 11k of the wall portion 11. This may have such a form that it tends to press the wall portion 11 against the surface of the cladding part 10 or cause it to follow the surface of the cladding part closely, as illustrated in FIG. 2. When the stiffening element is manually removed from the surface of the cladding part 10 beyond a dead center, it jumps, or folds, into a second position in which it exerts a force that presses the wall portion away from the surface of the cladding part 10, as illustrated in FIG. 1. In other words: the stiffening element, or the wall portion 11, can deform and in the process be folded, formed, moved from the first position into the second position, and vice versa. This force keeps the wall portion 11 stretched out in a position in which it forms a portion of the outer wall region of the receptacle. That portion of the substrate that is bounded by the receptacle inner region 11i forms the rest of the region of the outer wall.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A cladding part, comprising:
a textile covering, wherein the textile covering forms a visible surface of a wall, wherein
at least one wall portion of the textile covering is transferable into a position in which the wall portion forms at least one outer wall region of a receptacle.

2. The cladding part according to claim 1, wherein
the at least one wall portion is transferable into a position in which the cladding part does not have a receptacle.

3. The cladding part according to claim 1, wherein
the at least one wall portion is flexible.

4. The cladding part according to claim 1, wherein
the at least one wall portion is transferable from the position in which the wall portion forms the at least one outer wall region of the receptacle into a position in which the cladding part does not have the receptacle, and vice versa.

5. The cladding part according to claim 1, wherein
the textile covering is formed of a same textile throughout, including the wall portion.

6. The cladding part according to claim 1, wherein
the textile covering is intrinsically stiff.

7. The cladding part according to claim 1, wherein
the at least one wall portion has a stiffener.

8. The cladding part according to claim 2, wherein
the at least one wall portion is translucent in the position in which the cladding part does not have the receptacle.

9. The cladding part according to claim 1, wherein
the at least one wall portion is non-translucent in the position in which the wall portion forms the at least one outer wall region of the receptacle.
